(19) United States
(12) Patent Application Publication
(10) Pub. No.: US 2011/0238744 A1
(43) Pub. Date: Sep. 29, 2011

(54) IMAGE DISPLAY APPARATUS AND IMAGE DISPLAY METHOD

(75) Inventor: Toru Karasawa, Kamiina-gun (JP)

(73) Assignee: SEIKO EPSON CORPORATION, Tokyo (JP)

(21) Appl. No.: 13/072,339

(22) Filed: Mar. 25, 2011

(30) Foreign Application Priority Data
Mar. 29, 2010 (JP) 2010-074388

(51) Int. Cl. G06F 15/16

(52) U.S. Cl. 709/203

(57) ABSTRACT

An image display apparatus which displays images in accordance with a scenario setting a display procedure, includes: a transmission unit which, in accordance with a request from a client terminal connected so that a bi-directional communication is possible, transmits scenario creation information for specifying the display order defined by the scenario, and specifying image information necessary to specify an image to be displayed for each step of the display order, to the client terminal; a scenario information acquisition unit which receives the transmission of the already specified scenario creation information from the client terminal when the scenario creation information is specified by the client terminal, and acquires the display order and image information included in the scenario creation information of which the transmission is received; and a display execution unit which executes an image display using the acquired image information in accordance with the display order.

### CROSS-REFERENCE

The entire disclosure of Japanese Patent Application No. 2010-074388 filed Mar. 29, 2010 is expressly incorporated by reference herein.

### BACKGROUND

1. Technical Field

The present invention relates to an image display apparatus which displays images in accordance with a scenario setting a display procedure including an image display order.

2. Related Art

A projector of a projection type display apparatus which is one example of an image display apparatus, as it can enlarge and display an image, is being heavily used as an image display apparatus for a general consumer, other than for the purpose of presentation. When carrying out an image display using the projector, as a part of the diversified image displays, a scenario display technique has been proposed wherein images are sequentially displayed in accordance with a scenario (for example, JP-A-2007-316647).

As a starting of an application program, and a scenario creation using the program, on a computer are indispensable to the scenario display technique proposed in JP-A-2007-316647, this has led to a demand for a simpler scenario display technique.

### SUMMARY

An advantage of some aspects of the invention is to provide an image display apparatus with which a simplified scenario display is possible.

An aspect of the invention is directed to an image display apparatus which displays images in accordance with a scenario setting a display procedure including a display order specifying a sequence of image display, includes a transmission unit which, in accordance with a request from a client terminal connected so that a bi-directional data transmission is possible, transmits scenario creation information for specifying the display order included in the display procedure set by the scenario, and specifying image information necessary to specify an image to be displayed for each step of the display order, to the client terminal; a scenario information acquisition unit which receives the transmission of the already specified scenario creation information from the client terminal when the scenario creation information is specified by the client terminal, and acquires the display order and image information included in the scenario creation information of which the transmission is received; and a display execution unit which executes an image display using the acquired image information in accordance with the display order.

With the image display apparatus including the heretofore described configuration, in order to carry out the image display in accordance with the scenario, the client terminal only becomes involved in specifying the display order and image information necessary to create the scenario. Then, the image display in accordance with the scenario is done by the image display using the image information specified by the client terminal being executed in accordance with the display order specified by the client terminal. As a result of this, according to the image display apparatus including the heretofore described configuration, it is possible to easily carry out the image display in accordance with the scenario by way of an information specification on the client terminal side.

The image display apparatus may be configured as follows. For example, dramatic effect information which, being included in the scenario in addition to the display order and image information, is involved in a dramatic effect of the image during the image display, is transmitted to the client terminal, included in the scenario creation information, and the dramatic effect information is acquired, in addition to the display order and image information. On that basis, the dramatic effect during the image display for each step of the display order is executed based on the acquired dramatic effect information. By arranging in this way, it is possible to carry out the image display in accordance with the scenario, by way of the information specification on the client terminal side, easily and including the dramatic effect.

Also, by the scenario information acquisition unit creating a scenario file based on the acquired display order and image information, it is possible to reproduce the scenario image display using the scenario file once created.

Also, by storing the created scenario file in the storage unit, it is possible to reproduce the scenario image display even in a condition in which the image display apparatus is not connected to the client terminal.

Also, by transmitting the scenario creation information to the client terminal, as a web page, in conformity with an HTTP format data transfer, it is possible to cause the image display apparatus to carry out the scenario image display using a client terminal which can execute a web browser.

Another aspect of the invention is directed to an image display method with an image display apparatus which displays images in accordance with a scenario setting a display procedure including a display order specifying a sequence of image display. The method includes, in accordance with a request from a client terminal connected so that a bi-directional data transmission is possible, transmitting scenario creation information for specifying the display order included in the display procedure set by the scenario, and specifying image information necessary to specify an image to be displayed for each display order, to the client terminal; receiving the transmission of the already specified scenario creation information from the client terminal when the scenario creation information is specified by the client terminal, and acquiring the display order and image information included in the scenario creation information of which the transmission is received; and displaying an image using the acquired image information in accordance with the display order.

According to the image display method, in order to carry out the image display in accordance with the scenario, the client terminal only becomes involved in specifying the display order and image information necessary to create the scenario. Then, the image display in accordance with the scenario is done by the image display using the image information specified by the client terminal being executed in accordance with the display order specified by the client terminal. As a result of this, according to the image display apparatus including the heretofore described configuration, it is possible to easily carry out the image display in accordance with the scenario by way of an information specification on the client terminal side.

Still another aspect of the invention is directed to a scenario creation method in an image display system including an image display apparatus, which displays images in accordance with a scenario setting a display procedure including a display order specifying a sequence of image display, and a client terminal connected to the image display apparatus so that a bi-directional data transmission is possible. The client terminal requests the image display apparatus to transmit scenario creation information for specifying the display order included in the display procedure set by the scenario, and specifying image information necessary to specify an image to be displayed for each step of the display order, sets the display order and image information in the scenario creation information received from the image display apparatus, and transmits the scenario creation information, in which is set the display order and image information, to the image display apparatus.

According to the scenario creation method, the client terminal, simply by setting required items in the scenario creation information acquired from the image display apparatus, can create a scenario specifying a selection and display order of images which the image display apparatus is caused to display.

### BRIEF DESCRIPTION OF THE DRAWINGS

The invention will be described with reference to the accompanying drawings, wherein like numbers reference like elements.

FIG. 1 is an illustration showing an overall configuration of a scenario creation and reproduction system including a projector as an embodiment of the invention.

FIG. 2 is an illustration showing an outline configuration of the projector.

FIG. 3 is a flowchart showing a series of processing procedures of a scenario creation and reproduction.

FIG. 4 is an illustration showing a web page used in a scenario file for the scenario creation.

FIG. 5 is an illustration showing a script description example of the created scenario file.

### DESCRIPTION OF EXEMPLARY EMBODIMENTS

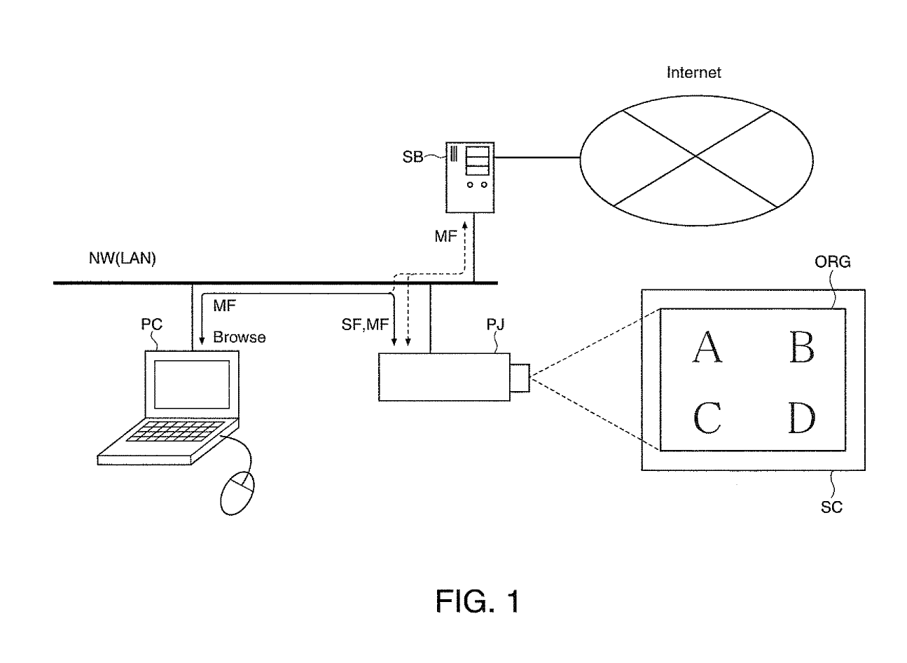

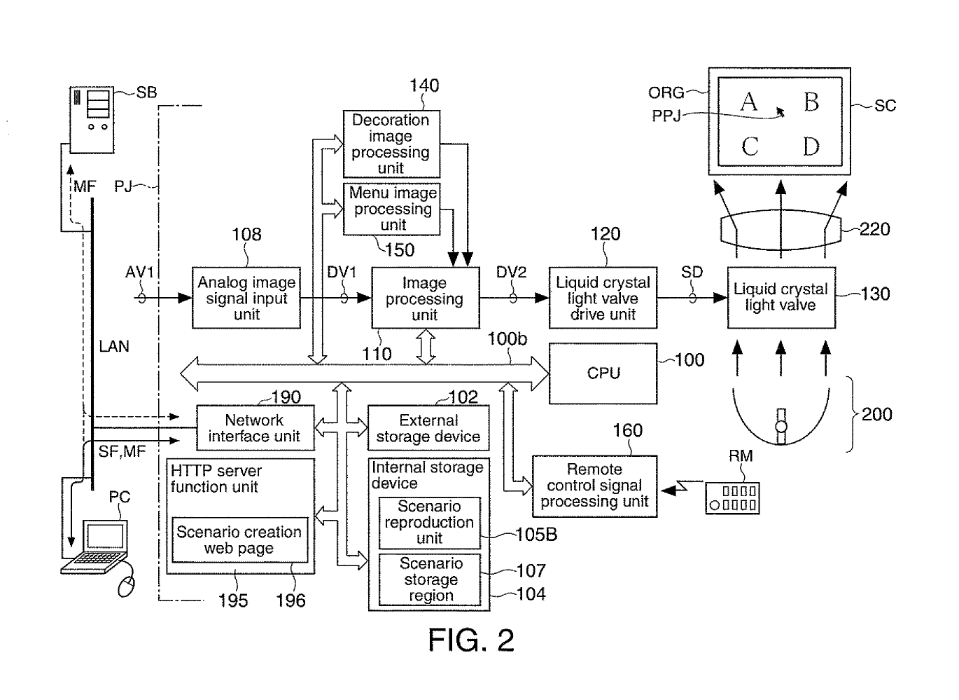

Hereafter, a description will be given of an embodiment of the invention, based on a working example when the embodiment is applied to a projector. FIG. 1 is an illustration showing an overall configuration of a scenario creation and reproduction system including a projector PJ as the embodiment of the invention, and FIG. 2 is an illustration showing an outline configuration of the projector PJ. The scenario creation and reproduction system, including the projector PJ as a projection type image display apparatus which performs a main function of creating and reproducing a scenario, and a computer PC which performs an ancillary function of creating the scenario, connects the two via a network NW (for example, an LAN) so that a bi-directional data transmission is possible. In the working example, on the assumption that an image to be displayed in accordance with the scenario is acquired via the network NW, a file server SB is connected to the network NW.

The computer PC stores in a memory a material file MF of an image or the like which is a display target during the image display in accordance with the scenario by the projector PJ, and supplies the material file MF to the projector PJ as necessary. The file server SB is connected to the Internet and, apart from storing and saving the material file MF in a memory, retrieves and stores a material file MF published on the Internet too. The projector PJ of the working example, being able to reproduce a plurality of formats of material files, stores the material file MF too. Then, the projector PJ, in accordance with a scenario file SF created in conjunction with the computer PC, retrieves the material file MF stored in the projector PJ itself or in the computer PC or file server SB, and causes an original image ORG corresponding to the material file MF to be displayed on a screen SC, as will be described hereafter. The projector PJ can also be arranged in such a way as to be connected to the Internet, and to retrieve a material file MF on the network on its own.

The projector PJ, as shown in FIG. 2, includes a CPU 100, an external storage device 102, an internal storage device 104 such as an ROM or an RAM, an analog image signal input unit 108, an image processing unit 110, a liquid crystal light valve drive unit 120, a liquid crystal light valve 130, a decoration image processing unit 140, a menu image processing unit 150, a remote control signal processing unit 160, a network interface unit 190, and a server function unit 195. The liquid crystal light valve 130 is approximately uniformly illuminated by an illumination optical system 200, and an image light modulated in the liquid crystal light valve 130 is projected onto the screen SC by a projection optical system 220. A light source used in the illumination optical system 200 may be a solid light source such as a discharge light source lamp configured of an extra high pressure mercury-vapor lamp, a metal halide lamp, or the like, or a light emitting diode (LED) light source. Also, not only the liquid crystal light valve 130, but a reflective optical modulation device such as a reflective liquid crystal light valve, a micromirror array device which controls the emission direction of an incident light for each of micromirrors acting as pixels, and thereby modulates the light emitted from the light source, or the like, may be used.

The analog image signal input unit 108 has a function of, when supplied with an analog image signal AV1 from an external image supply device (not shown), AD converting the analog image signal AV1 and outputting digital image data DV1. As the analog image signal AV1, an image signal such as, for example, an RGB signal representing a computer image supplied from a personal computer, or a composite image signal representing a moving image supplied from a video recorder or a television receiver, is supplied.

The image processing unit 110 has a function of generating synthetic image data wherein supplied original image data and decoration image data are synthesized. Because of this, it is possible to cause an image, wherein a decoration image such as a pointer image PPJ represented by the decoration image data is superimposed on the original image ORG represented by the original image data, to be displayed on the screen SC. The image processing unit 110 once writes the supplied original image data into an unshown frame memory, synthesizes the original image data and decoration image date when retrieving the original image data written in the frame memory, and supplies synthesized image data DV2 to the liquid crystal light valve drive unit 120.

As the original image data, the digital image data DV1 supplied from the analog image signal input unit 108, page-by-page page image data supplied from the internal storage device 104, menu image data supplied from the menu image processing unit 150, or the like, are used. Meanwhile, as the decoration image data, decoration image data supplied from the decoration image processing unit 140 are used. Herein, the decoration image, meaning an image prepared independently of the original image, is displayed on the screen SC by being superimposed on the original image.

The liquid crystal light valve drive unit 120 generates image display data SD in accordance with the image data DV2 supplied from the image processing unit 110. The liquid crystal light valve 130 is driven using the image display data SD. At this time, the liquid crystal light valve 130 modulates the light from the illumination optical system 200 to an image light representing an image.

The decoration image processing unit 140 has a function of generating the decoration image data representing the decoration image, and supplying them to the image processing unit 110. Specifically, the decoration image processing unit 140 generates various decoration image data such as a specific shape image (for example, an index image) and a drawing image (for example, a box image or a surrounding frame image) which are formed in a desired size by specifying a range using the pointer image PPJ, and supplies them to the image processing unit 110.

The menu image processing unit 150 has a function of generating the menu image data representing the menu image, and supplying them to the image processing unit 110. A user can, in accordance with the menu image, set various settings relating to the projector PJ.

The network interface unit 190 has a function of connecting the projector PJ to the LAN, receiving an input of data necessary to create the scenario file SF, or receiving the material file MF used in the scenario file SF, from the computer PC via the LAN, and supplying the data or material file MF to the internal storage device 104 via a bus 100b.

The server function unit 195, performing a function as a server conforming to an HTTP format data transfer, outputs a scenario creation web page 196 for creating the scenario file SF, in conjunction with the network interface unit 190, in accordance with a request from the computer PC. Also, the server function unit 195 also performs a function of creating the scenario file SF based on the data received from the computer PC. That is, the network interface unit 190 and server function unit 195 function as a transmission unit and scenario information acquisition unit according to some aspects of the invention in conjunction with the CPU 100 and an executed program.

The internal storage device 104 includes a scenario reproduction unit 105E for reproducing the scenario file SF already created by the server function unit 195, and a scenario storage region 107 in which is stored the scenario file SF already created by the server function unit 195 and the material file MF supplied from the network interface unit 190.

In the working example, the material file MF supplied from the network interface unit 190 is stored in the scenario storage region 107 in the internal storage device 104, but an arrangement may be such that it is stored in the external storage device 102 or a memory card mounted in an unshown memory card control unit.

The scenario reproduction unit 105B can retrieve a plurality of formats of material files MF created using a plurality of kinds of application program. That is, the scenario reproduction unit 105B includes a viewer function with which it is possible to view details of the plurality of formats of material files MF created using the plurality of kinds of application program. The scenario reproduction unit 105B, in accordance with the scenario file SF, retrieves the material file MF stored in the scenario storage region 107 or file server SB, and supplies the page-by-page page image data to the image processing unit 110 as the original image data. The projector PJ projects the image based on the original image data supplied in this way onto the screen SC. That is, the scenario reproduction unit 105B, cooperated with the CPU 100 and executed program, performs as a display execution unit according to some aspects of the invention.

The remote control signal processing unit 160, based on a control signal from a remote control RN, controls the function of each unit of the projector PJ. For example, the remote control signal processing unit 160 can control the function of the decoration image processing unit 140 based on the control signal from the remote control RM, and superimpose the pointer image PPJ in a desired position in the original image ORG.

In this specification, the computer, being a concept including a hardware device and an operation system, means the hardware device which acts by being controlled by the operation system. Also, in a kind of case in which the operation system is not necessary, and the hardware device is caused to act by an application program alone, the hardware device itself corresponds to the computer. Some of the heretofore described functions may be realized by the operation system, rather than by the application program.

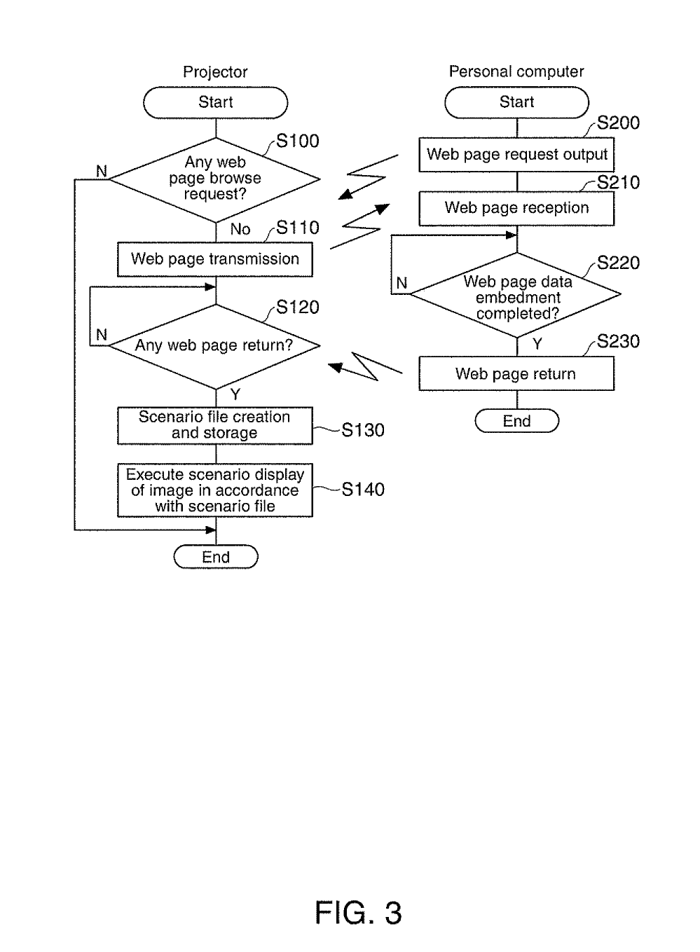

Next, a description will be given of a scenario creation and reproduction carried out by the projector PJ of the working example. FIG. 3 is a flowchart showing a series of processing procedures of the scenario creation and reproduction. FIG. 3 shows a projector PJ side process and a computer PC side process in parallel.

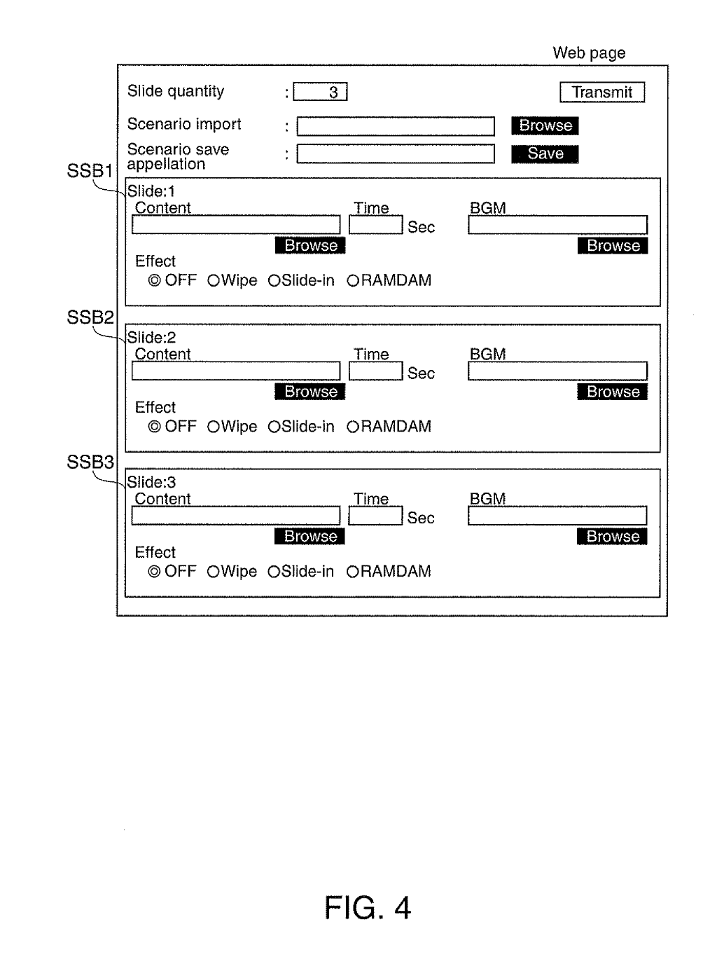

The projector PJ waits for a web page browse request from the computer PC (step S100) and, in the event that there is no request, finishes this routine without carrying out any process. The computer PC side, after specifying the projector PJ using its IP address or the like, outputs the web page browse request to the projector PJ by way of a mouse operation or the like by the user (step S200). The projector PJ receives the browse request from the computer PC side, transmits a web page for creating the scenario file SF to the computer PC (step S110), and waits until there is a return of the page (step S120). FIG. 4 is an illustration showing one example of a web page used in the scenario file SF for the scenario creation.

As shown in FIG. 4, the web page includes at the top a slide quantity data input section into which are input slide quantity data equivalent to the number of images included in a scenario according to the scenario file SF, a transmission button with which an already filled-in web page or details filled into the web page are transmitted to the projector PJ, an import data input section for specifying an import destination of the scenario, and an appellation input section for specifying an appellation of the scenario when saving the scenario, below which it includes a number of slide information input blocks SSB1 to SSB3 equivalent to the slide quantity. In the working example, as a value 3 is made an initial value as the slide quantity, the web page includes three slide information input blocks SSB1 to SSB3, as shown in the drawing, but when the computer PC side sets a value larger than the value 3 as the slide quantity data, the web page includes a number of slide information input blocks equivalent to the specified numerical value.

The slide information input blocks SSB1 to SSB3 are arranged with their image display order set in advance, indicating that the slide information input block SSB1 is a first display image, and subsequently, images are scenario displayed in the order of the slide information input blocks SSB2 and SSB3. In this case, it is also possible to include in the web page a data input section in which to set a display order, and make the specified order a display order. Each of the slide information input blocks SSB1 to SSB3 includes a content input section for specifying content information with which it is possible to specify the material file MF of an image which is a display target, a time input section in which to specify an image display time, a BGM input section for specifying content information with which it is possible to specify, the material file MF of a musical performance incorporated as a background music (BGM), and an effect specification input section in which to specify Wipe, Slide-in, and RAMDAM as three dramatic effects during the image display. It is also possible to configure in such a way as to specify a dramatic effect other than this.

Then, each of the import data input section and the content input section and BGM input section of each slide information input blocks SSB1 to SSB3 is furnished with a browse button in such a way that it is possible to specify the material file MF already stored in the computer PC, or the projector PJ or file server SB, and the material file MF already stored in a material provision server or the like on the Internet. That is, the user inputs a file name, with which it is possible to specify the material file MF, and a file storage place into the content input section and BGM input section. Also, the user inputs the numerical value of a time for which to display an image into the time input section, and specifies the necessity of the three dramatic effects by checking off check boxes.

The computer PC side receives the web page shown in FIG. 4 (step S210), waits for the user to complete an input into each heretofore described section (step S220) and, when the input is completed, and the transmission button is pressed, returns the already filled-in web page or the details filled into the web page to the projector PJ (step S230) This is the end of the process on the computer PC side. In the working example, as the import data input section and the browse buttons are included in the web page, as shown in FIG. 4, it is possible to do in the following way. After the computer PC side inputting the web page from the projector PJ, that is, when waiting for a data input in step S220, it is possible to specify a web page corresponding to the scenario file SF already stored in the projector PJ using the browse button, and retrieve the specified web page from the projector PJ. As data are already input into each of the sections in the retrieved web page, it is sufficient to, after editing the web page, return it from the computer PC to the projector PJ.

The projector PJ side receives the return of the web page from the computer PC, creates the scenario file SF in step S130, and stores and saves it in the scenario storage region 107. When there is no operation of a save button corresponding to the scenario appellation input section in the web page of FIG. 4, the scenario file SF is not stored in the scenario storage region 107 in step S130, but is used for one scenario display.

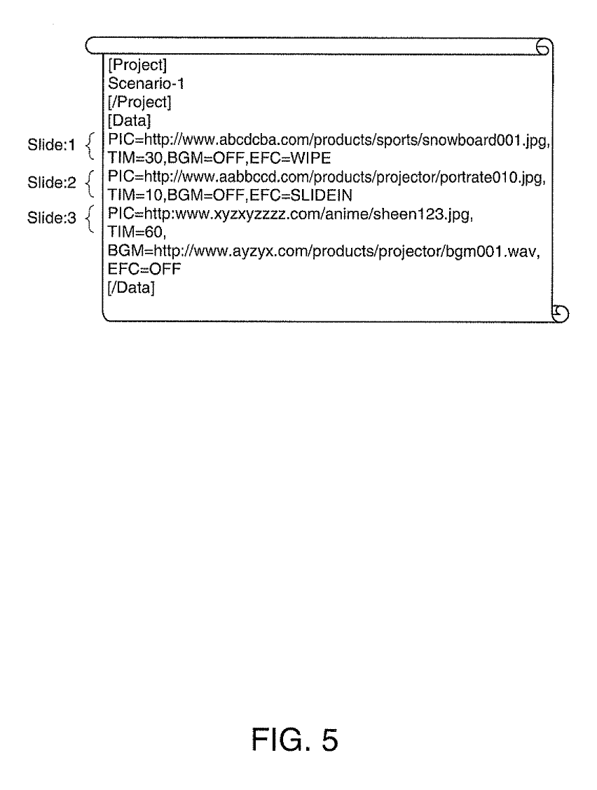

For the creation of the scenario file SF in step S130, the descriptions in the input sections included in the web page which has been returned from the computer PC are read, and the scenario file SF is created with the descriptions as file creation data. FIG. 5 is an illustration showing a script description example of the created scenario file SF.

As shown in the drawing, a file data prescript with which it is possible to specify a material file MF which should be displayed in accordance with the sequence of a display order 1 to a display order 3 in order, a file display time prescript, a BGM necessity and musical performance file data prescript, and a dramatic effect necessity and dramatic effect detail prescript are included in this script. For example, a script for Slide: 1 includes a URL wherein, as well as a JPEG format image file (hereafter a JPEG file) being specified as the material file MF using snowboard001, a file storage destination is specified before a description thereof. Also, it shows that a display of the JPEG file for thirty seconds or the BGM are not necessary, and that Wipe has been selected as the dramatic effect by the user. In order to specify the material file MF, apart from the heretofore described URL notation, for example, an arrangement may be such as to describe a file storage place and file name when the files stored in the projector PJ or computer PC are rendered into a tree notation.

On the scenario file SF being created on the projector PJ side in this way, the projector PJ executes a scenario display process in accordance with the scenario file SF (step S140). That is, the projector PJ, using the scenario reproduction unit 105B in the internal storage device 104, sequentially retrieves the material files MF in accordance with the scenario script description, and sequentially supplies the page-by-page page image data to the image processing unit 110, as the original image data, in accordance with the image display order prescribed by the scenario file SF. By so doing, the projector PJ executes a scenario display wherein images are sequentially displayed and projected onto the screen SC for each page. This routine finishes accompanying the execution of the scenario display.

As heretofore described, with the projector PJ of the working example, in order to carry out the image display in accordance with the scenario, the computer PC only receives an input of data necessary to create the scenario file SF, in the web page, from the user (FIG. 3: steps S210 to S230), and it is not necessary to create the scenario file SF on the computer PC side. Then, the image display in accordance with the scenario is executed in accordance with the scenario file SF created on the projector PJ side. As a result of this, according to the projector PJ of the working example, it is possible to easily carry out the image display in accordance with the scenario by way of a simple data specification on the computer PC side.

Also, with the projector PJ of the working example, with regard to a dramatic effect of an image display when carrying out a scenario display too, the necessity of the dramatic effect and the details of the dramatic effect are comprehended on the projector PJ side by way of a simple operation of checking off the check box in the web page on the computer PC. On that basis, it is possible to easily carry out a scenario display coupled with the dramatic effect by way of a data specification on the computer PC side.

Also, with the projector PJ of the working example, the scenario file SF created by the projector PJ itself is stored in the scenario storage region 107. Therefore, by retrieving the stored scenario file SF, it is possible to repeatedly execute the scenario display in accordance with the scenario file SF. In addition to this, it is possible to edit the retrieved scenario file SF, and easily create a new scenario file SF on the projector PJ side, and versatility also improves.

A description has heretofore been given of the embodiment of the invention, but the invention, not being limited to the heretofore described embodiment, can be implemented in various forms without departing from the scope thereof. For example, in the working example, the projector PJ and computer PC are connected by the LAN in such a way that a bi-directional data transmission is possible, but the computer PC and projector PJ can also be directly connected by a USB cable or the like.

What is claimed is:

1. An image display apparatus which displays images in accordance with a scenario setting a display procedure including a display order specifying a sequence of image display, comprising:
a transmission unit which, in accordance with a request from a client terminal connected so that a bi-directional data transmission is possible, transmits scenario creation information for specifying the display order included in the display procedure set by the scenario, and specifying image information necessary to specify an image to be displayed for each step of the display order, to the client terminal;
a scenario information acquisition unit which receives the transmission of the already specified scenario creation information from the client terminal when the scenario creation information is specified by the client terminal, and acquires the display order and image information included in the scenario creation information of which the transmission is received; and
a display execution unit which executes an image display using the acquired image information in accordance with the display order.

2. The image display apparatus according to claim 1, wherein:
the transmission unit transmits dramatic effect information which, being further included in the scenario in addition to the display order and image information, is involved in a dramatic effect of the image during the image display, to the client terminal, included in the scenario creation information,
the scenario information acquisition unit acquires the dramatic effect information, in addition to the display order and image information, and
the display execution unit, based on the acquired dramatic effect information, executes the dramatic effect during the image display for each step of the display order.

3. The image display apparatus according to claim 1, wherein
the scenario information acquisition unit creates a scenario file based on the acquired display order and image information.

4. The image display apparatus according to claim 3, further comprising:
a storage unit which stores the scenario file.

5. The image display apparatus according to claim 1, wherein
the transmission unit, in conformity with an HTTP format data transfer, transmits the scenario creation information to the client terminal as a web page.

6. An image display method with an image display apparatus which displays images in accordance with a scenario setting a display procedure including a display order specifying a sequence of image display, comprising:
in accordance with a request from a client terminal connected so that a bi-directional data transmission is possible, transmitting scenario creation information for specifying the display order included in the display procedure set by the scenario, and specifying image information necessary to specify an image to be displayed for each step of the display order, to the client terminal;
receiving the transmission of the already specified scenario creation information from the client terminal when the scenario creation information is specified by the client terminal, and acquiring the display order and image information included in the scenario creation information of which the transmission is received; and
displaying an image using the acquired image information in accordance with the display order.

7. The image display method according to claim 6, further comprising:
transmitting dramatic effect information which, being included in the scenario in addition to the display order and image information, is involved in a dramatic effect of the image during the image display, to the client terminal, included in the scenario creation information;
acquiring the dramatic effect information, in addition to the display order and image information; and
based on the acquired dramatic effect information, executing the dramatic effect during the image display for each step of the display order.

8. The image display method according to claim 6, further comprising:
creating a scenario file based on the acquired display order and image information.

9. The image display method according to claim 8, further comprising:
storing the scenario file.

10. The image display method according to claim 6, further comprising:
in conformity with an HTTP format data transfer, transmitting the scenario creation information to the client terminal as a web page.

11. A creation method of a scenario setting a display procedure including a display order specifying a sequence of image display, in an image display system in which a client terminal and an image display apparatus are connected so that a bi-directional data transmission is possible, wherein
the client terminal
requests the image display apparatus to transmit scenario creation information for specifying the display order included in the display procedure set by the scenario, and specifying image information necessary to specify an image to be displayed for each step of the display order,
sets the display order and image information in the scenario creation information received from the image display apparatus, and
transmits the scenario creation information, in which is set the display order and image information, to the image display apparatus.

12. The scenario creation method according to claim 11, wherein
the scenario creation information includes dramatic effect information which, being included in the scenario in addition to the display order and image information, is involved in a dramatic effect of the image during the image display, and
the client terminal sets, in addition to the display order and image information, the dramatic effect information in the scenario creation information.
